(19) United States
(12) Patent Application Publication
(10) Pub. No.: US 2013/0229367 A1
(43) Pub. Date: Sep. 5, 2013

(54) Dynamic Patterns for Mobile Device Authentication

(71) Applicant: Michael W. Pinch, Rochester, NY (US)

(72) Inventor: Michael W. Pinch, Rochester, NY (US)

(21) Appl. No.: 13/709,048

(22) Filed: Dec. 9, 2012

Related U.S. Application Data
(60) Provisional application No. 61/606,441, filed on Mar. 4, 2012.

(51) Int. Cl. G06F 3/041

(52) U.S. Cl. CPC G06F 3/041
USPC 345/173

(57) ABSTRACT

Dynamic Patterns for Mobile Device Authentication is a computer-implemented method for authenticating to and unlocking a mobile device. The method comprises displaying a lock screen view with randomized placement of colored nodes and or numbered nodes and or other uniquely identified nodes on the mobile device to prevent unauthorized or inadvertent access to the mobile device's data. The mobile device, while locked, will detect a touch gesture corresponding to the placement of the uniquely identified nodes on a touch screen of the mobile device. The input touch gesture will vary for each authentication attempt based on the randomized placement of the uniquely identified nodes. A user is able to input the sequence of unique identifiers on the touch screen; and in response to input of the user-defined unique identifier sequence, causes the mobile device to unlock.

### CROSS REFERENCE TO RELATED APPLICATIONS

This nonprovisional utility patent application pertains to the invention described in and claims the benefit of Provisional Patent Application No. 61/606,441 filed on Mar. 4, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

This field relates to dynamic pattern touch gesture authentication to a mobile device.

2. Background Art

Some mobile devices, such as smart phones, include touch screens. These devices accept input by detecting movements, known as touch gestures, of fingers or other objects in contact with the touch screen. Upon detection of a touch gesture, the mobile device may execute an action.

Mobile devices generally include lock screens to prevent unauthorized or unintentional access to the device. Mobile devices running the Android operating system enable a user to define a touch pattern gesture from fixed nodes to unlock a touch screen. This feature, known as pattern unlock, enables a user to define a gesture to authenticate the user and unlock the device. However, the core issue with pattern-based systems used for authentication to mobile devices is that the excessive residue left behind on the touch screen allows an unauthorized user to follow the residue smudge on the screen to easily guess the pattern to unlock the device.

Systems and methods are needed that enable users to more securely access the functionality of a locked mobile device.

### BRIEF SUMMARY OF THE INVENTION

Embodiments enable a user to unlock a mobile device by inputting a touch gesture of a predefined sequence of uniquely identified nodes on a lock screen. While the mobile device is locked, a randomized placement of colored nodes and or numbered nodes and or other uniquely identified nodes on the mobile device is presented to the user. The input touch gesture will vary for each authentication attempt based on the randomized placement of the uniquely identified nodes. A user is able to input the sequence of unique identifiers on the touch screen; and in response to input of the user-defined unique identifier sequence, causes the mobile device to unlock.

Further embodiments, features, and advantages of the invention, as well as the structure and operation of the various embodiments of the invention are described in detail below with reference to accompanying drawings.

### BRIEF DESCRIPTION OF THE SEVERAL VIEWS OF THE DRAWING

The accompanying drawings, which are incorporated herein and form a part of the specification, illustrate the present invention and, together with the description, further serve to explain the principles of the invention and to enable a person skilled in the pertinent art to make and use the invention.

FIG. 1A is a drawing demonstrating three illustrative examples of display screens of a locked mobile device with randomized placement of uniquely identified nodes on the mobile device. These three examples are shown as Variation 1, Variation 2 and Variation 3. The uniquely identified nodes vary for each authentication attempt.

FIG. 1B is a drawing demonstrating the touch gestures the user would input in order to authenticate to the display screen with a randomized pattern. Variation 1, Variation 2 and Variation 3 correspond to the Variations in FIG. 1A.

### DETAILED DESCRIPTION OF THE INVENTION

As mentioned above, the core issue with pattern-based systems used for authentication to mobile devices is the excessive residue left behind on the touch screen makes a fixed pattern easy for an unauthorized user to guess. A solution to this problem is to ensure a different pattern is entered on each screen. This pattern matching system assigns a unique color, number, or other unique identifier to each node, and randomizes the placement of the nodes on each login attempt. The nodes must be arranged in a pattern such that the user is able to access each node from any point on the screen. In order to authenticate, the user would remember their unique identifier sequence.

Dynamic Patterns for Mobile Device Authentication is a computer-implemented method for authenticating to and unlocking a mobile device. The method comprises displaying a lock screen view with randomized placement of colored nodes and or numbered nodes and or other uniquely identified nodes on the mobile device to prevent unauthorized or inadvertent access to the mobile device's data. The mobile device, while locked, will detect a touch gesture corresponding to the placement of the uniquely identified nodes on a touch screen of the mobile device. The input touch gesture will vary for each authentication attempt based on the randomized placement of the uniquely identified nodes. A user is able to input the sequence of unique identifiers on the touch screen; and in response to input of the user-defined unique identifier sequence, causes the mobile device to unlock.

A summary of rules for this authentication method is listed in paragraphs 0020 through 0025.

Unlock screen will display a randomized pattern of uniquely identified nodes.

Nodes must be arranged in a pattern such that the user is able to access each node from any point on the screen.

User-defined authentication sequence must be a minimum of 4 nodes.

Nodes may be selected any number of times; however no node may be visited twice consecutively.

User inputs their pre-defined authentication sequence by selecting nodes displayed on the unlock screen.

Correct entry sequence of unique identifiers on the unlock screen will cause the device to unlock.

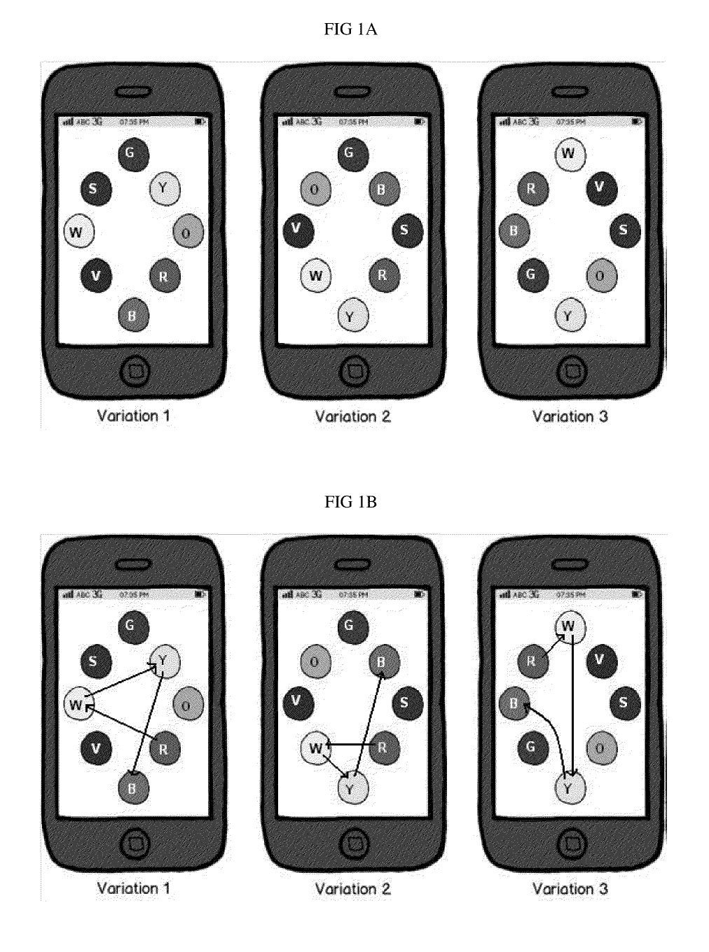

FIG. 1A is a drawing demonstrating three illustrative examples of display screens of a locked mobile device with randomized placement of uniquely identified nodes on the mobile device. These three examples are shown as Variation 1, Variation 2 and Variation 3. The uniquely identified nodes vary for each authentication attempt. Variations 1 is an illustrative example of unique identifier locations on the authentication screen for log in attempt one, Variation 2 is an illustrative example of unique identifier locations on the authentication screen for log in attempt two, and Variation 3 is an illustrative example of unique identifier locations on the authentication screen for log in attempt three. Node unique identifiers could be colors, numbers, letters, symbols, or any combination thereof.

FIG. 1B is a drawing demonstrating the touch gestures the user would input in order to authenticate to the display screen with a randomized pattern. Variation 1, Variation 2 and Variation 3 correspond to the Variations in FIG. 1A. In order to authenticate, the user would remember their sequence of unique identifiers. In an example where a user has defined their pass code to be R, W, Y, B, this figure uses arrows to indicate the touch gesture input required by the user to authenticate to the mobile device depending on the location of the R, W, Y, and B nodes.

1. A computer-implemented method for authenticating to and unlocking a mobile device, comprising: displaying a lock screen view with randomized placement of colored nodes and or numbered nodes and or other uniquely identified nodes on the mobile device to prevent unauthorized or inadvertent access to the mobile device's data; while the mobile device is locked: detecting a unique touch gesture corresponding to the placement of the uniquely identified nodes on a touch screen of the mobile device, wherein a user is able to input the sequence of unique identifiers on the touch screen; and in response to input of the user-defined unique identifier sequence, causes the mobile device to unlock.
